(19) United States
(12) Patent Application Publication
(10) Pub. No.: US 2004/0186634 A1
(43) Pub. Date: Sep. 23, 2004

(54) Adaptive potable water fill system for an aircraft

(76) Inventors: Patrick W. Lucky, Shoreline, WA (US); Craig P. Sundine, Snohomish, WA (US); Marat Denuski, Kenmore, WA (US)

Correspondence Address: ARTZ & ARTZ, P.C., 28333 TELEGRAPH RD., SUITE 250, SOUTHFIELD, MI, 48034, US

(21) Appl. No.: 10/390,195

(22) Filed: Mar. 17, 2003

(51) Int. Cl. G06F 17/00

(52) U.S. Cl. 701/3

(57) ABSTRACT

An adaptive potable water fill system (46) for an aircraft (10) is used to control the amount of water stored within a storage tank (14). The adaptive potable water fill system (46) includes a controller (48) that is coupled to a level sensor (22) within the storage tank (14). The controller (48) may also be coupled to various aircraft controls (50) and the aircraft communication system (52), and a memory (66) having a database (68) therein for storing airplane configuration information. A user interface (62) is used to enter preflight information. The controller (48) uses information from preloaded algorithms, memory stored historic data, the water level sensor, the airplane configuration database, and the preflight information to determine the amount of water desired for the particular flight. A fill valve (18) may be automatically controlled by the system to stop the flow of water into the storage tank (14) when the desired amount of water has been reached.

### TECHNICAL FIELD

The present invention relates generally to the potable water system for an aircraft, and more particularly, to a system for predicting the amount of water needed based on various parameters, and controlling the quantity of water uplifted into an aircraft based on those predictions.

### BACKGROUND ART

Airline operators load potable water for use in galleys and lavatories before each flight. The holding tanks on the flights are typically filled to capacity even though there will be leftover water at the end of the flight. Typically this is done because it is difficult to predict how much water is required and difficult to coordinate instructions from a central point to ground crews at various airports. Consequently, the potable water system is inefficient in that the aircraft carries more weight than is necessary. Increasing the weight of the aircraft increases the amount of fuel required.

Other operators attempt to load enough water that is expected to be used for a given flight. Because of the variables involved, such a process is typically not economically feasible.

It would therefore be desirable to provide a system for easily determining, monitoring, and controlling the amount of potable water required for a flight.

### SUMMARY OF THE INVENTION

The present invention provides a system and method for an adaptive potable water system for an aircraft that reduces unnecessary weight by reducing excessive amounts of water loaded in the system.

In one aspect of the invention, an adaptive water fill system for an aircraft includes an airplane configuration database that generates an airplane configuration signal, a water level sensor for generating a water tank level signal, a memory, a user interface for entering the preflight information in memory and a controller. The controller generates a fill amount signal in response to preloaded algorithms and historic data, the airplane configuration signal, the tank level signal, and the preflight information. The system may also include a link to aircraft wide data buses for automatic entering of pre-flight information

In addition, the fill system includes a fill valve that is controlled by the controller. The fill valve is controlled in response to the fill amount signal.

In a further aspect of the invention, a method of controlling a potable water system on an aircraft comprises: providing an airplane configuration having configuration information therein, generating a water tank level signal, storing preflight information into a database, and determining a fill amount in response to the configuration information, the water level signal and the preflight information.

One advantage of the invention is that the system along with predicting the amount of water needed to service a particular flight, the system is also adaptive in that it may collect information regarding particular flights, such as water usage, so that later predictions may be more accurate.

Another advantage of the invention is that because the system is highly automated, the implementation is more likely which in turn results in less fuel consumption by the aircraft. The highly automated aspect thus allows easy use by ground crews. The system eliminates the administrative costs of determining the appropriate water quantity for a particular flight.

Another advantage of the invention is that during operation the amount of water may also be monitored so that water may be conserved if too much water is being used or water may be dumped while in flight if a prediction of extra water is determined.

Other aspects and advantages of the present invention will become apparent upon the following detailed description and appended claims, and upon reference to the accompanying drawings.

### BRIEF DESCRIPTION OF THE DRAWINGS

FIG. 1 is a systematic view of the adaptive potable water system according to the present invention.

FIG. 2 is a front view of a service panel of the system of FIG. 1.

FIG. 3 is a flow chart of a method for operating the adaptive potable water fill system according to the present invention.

### BEST MODES FOR CARRYING OUT THE INVENTION

In the following figures the same reference numerals will be used to identify the same components.

The present invention is described with respect to various parameters and data that may be used in the determination of the amount of water required for a particular flight. Those skilled in the art will recognize that various combinations and further data may be used in the system.

The present invention may also be used in other water storage delivery system techniques such as those using air pressurized tanks.

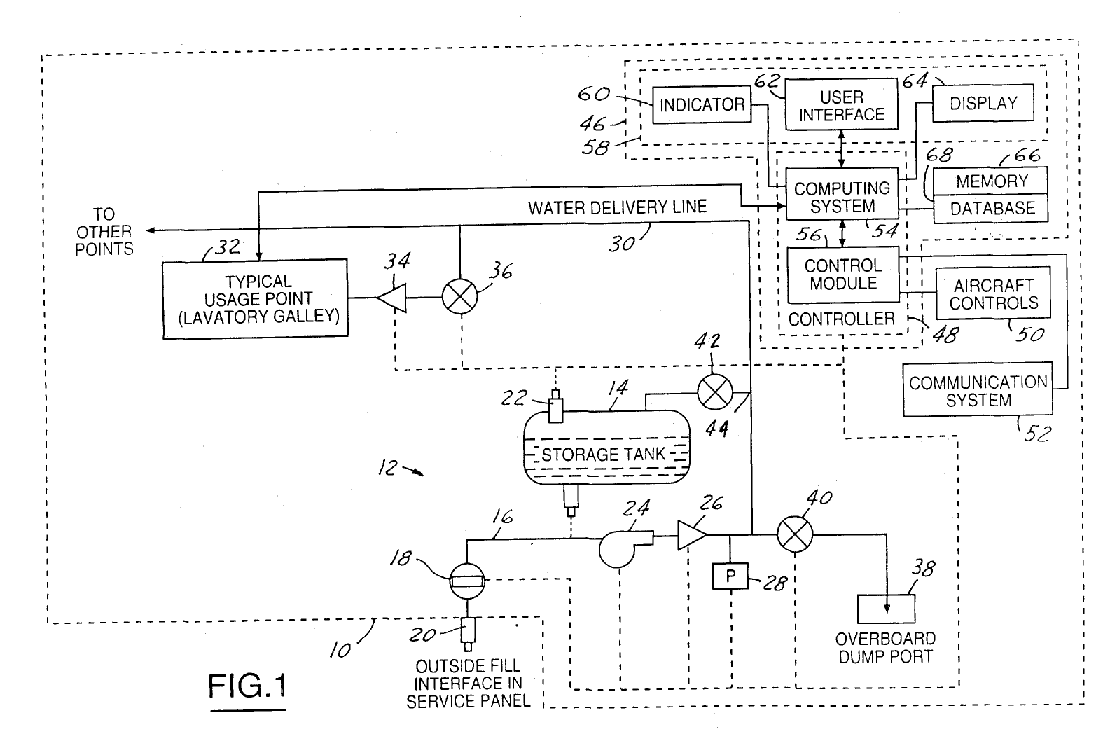

Referring now to FIG. 1, an aircraft is generally illustrated by box 10. The aircraft includes a potable water system 12 that includes a storage tank 14. Although one storage tank is illustrated, a number of storage tanks may be used in implementation, particularly on larger aircraft. Storage tank 14 has a supply line that is coupled through a motorized valve to a fill interface 20. Fill interface 20 is used for connecting an outside water source on the ground so that fresh potable water may be delivered to the storage tank 14. Valve 18, as will be further described below, is used to stop the flow of water to the storage tank. The storage tank 14 further includes a level sensor 22 that generates a water level signal corresponding to the amount of water within the tank. Potable water system 12 may also include a pump 24, a flow or quantity sensor 26, and a pressure sensor 28 that are used to couple the storage tank 14 to a water delivery line 30. The water delivery line 30 is used to deliver water to a typical usage point 32 such as a lavatory or galley. Water delivery line 30 is coupled to typical usage point 32 through a flow or quantity sensor 34 and a motorized valve 36. The storage tank 14 is also coupled to the water delivery line through recirculation valve 42 and recirculation line 44. The recirculation portion is used to prevent overheating within the pump and to provide distribution pressure regulation. The potable water system 12 may also include a dump port that is coupled to the storage tank 14 through a motorized valve 40. The actuation of motorized valve 40 may be used to purge the storage tank 14 of an excessive amount of water.

An adaptive potable water fill system 46 is coupled to the potable water system 12. The adaptive potable water fill system 46 includes a controller 48 that may be coupled to various control portions of the aircraft such as aircraft controls 50 and communication system 52. As will be further described below, various flight conditions may be provided from the aircraft controls 50 or relayed to the controller 48 from the ground through communication system 52. The conditions may include time or distance remaining, probability of routing or landing delays due to weather and the like.

Controller 48 includes a computing system 54 that may be microprocessor-based. Controller 48 also includes a control module 56. Controller 48 is electrically coupled to the motorized valves 18, 36, 40, and 42. Controller 48 is also electrically coupled to flow or quantity sensor 34, level sensor 22, pump 24, flow or quantity sensor 26, pressure sensor 28, and to a service panel 58. Service panel 58 may include but is not limited to an indicator 60, a user interface 62, and a display 64. Indicator 60 may, for example, be an audible indicator such as a buzzer or speaker or a visual indicator such as an LED or other type of light or any other type indicator. User interface 62 may comprise various types of user interfaces including buttons, a touch screen, a keyboard, a menu driven mouse type system, or a laptop computer. The display 64 may comprise a conventional computer monitor, an LCD screen, or other types of displays. Each of the components within service panel 58 is coupled to controller 48.

Controller 48 may also be coupled to a memory 66. Memory 66 is illustrated as a separate component. However, those skilled in the art will recognize that memory 66 may also be included within computing system 54. Memory 66 is used to store various parameters, collect various parameters from the user interface 62, and collect and store information from aircraft controls 50, communication system 52, or from the various sensors, pumps and valves used within the system. Memory 66 may also be used to store thresholds such as a water fill threshold for the storage tank 14. The memory 66 may also be used to store a database 68 of various information such as typical flight times, distances, and various airplane configuration information about the aircraft such as the amount of passengers, the number of galleys and lavatories, and the like. Such information will be further described below.

Based on various inputs, the controller 48 determines a fill amount on the ground. Also, during flight the controller 48 may be used to generate a desired amount of water so that rationing or dumping may be performed. This will be further discussed below. Control module 56 may be used to provide the electrical activation signals for the motorized valves 36, 18, 40, and 42. Although control module 56 and computing system 54 are illustrated as separate components, the components may be formed integrally.

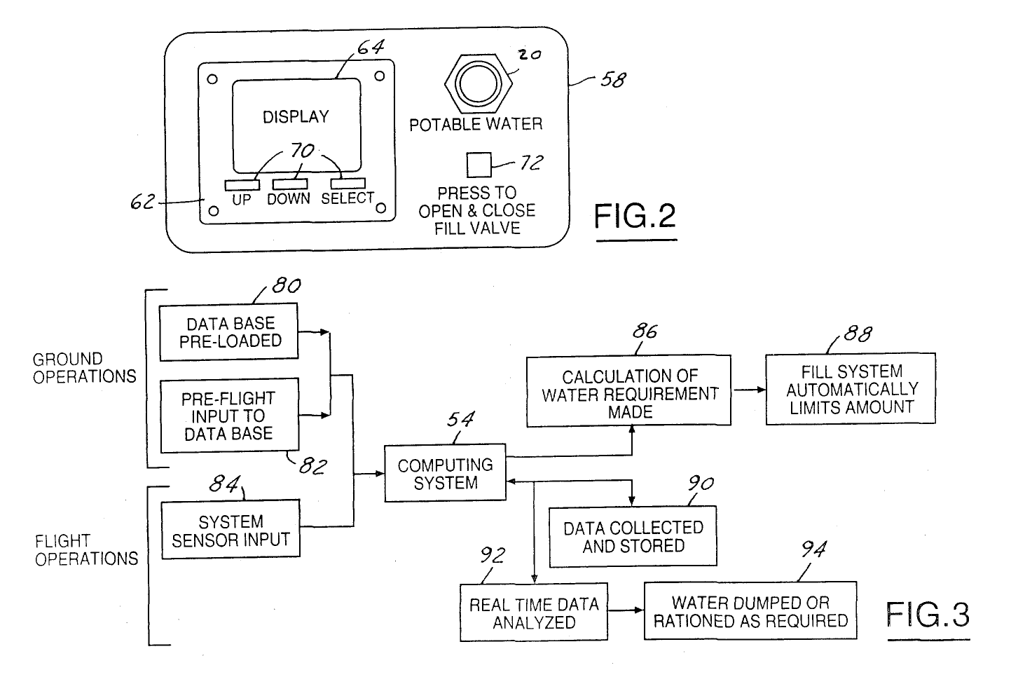

Referring now to FIG. 2, one embodiment of service panel 58 is illustrated. Service panel 58 is shown having display 64, buttons 70 that form user interface 62 and a manual valve control button 72. The display 64 may be used to indicate various modes of operation as will be described below. The panel 58 may be located and integrally formed within the aircraft 10. Also, the system may be included in a separate device that is interfaced with the aircraft by ground personnel. Fill interface 20 is used for connecting ground water sources to the aircraft 10. A service panel such as 58, with only the display 64 and buttons 70, can be located within the cabin of the aircraft 10 for use by flight attendants or integrated into flight deck controls.

Referring now to FIG. 3, a flow chart of a method for operating the adaptive potable water fill system 46 is illustrated. In block 80, the database is preloaded. The preloaded information defines the general airplane configuration. This information may be loaded at the factory but may be changed in the field as required. The parameters include but are not limited to seating configuration, number of lavatories and galleys, and the storage tank capacity. Other items that may be loaded in the database by operators include personal or company preferences for the allowable risk to having a water shortage, and the types of service they furnish including such items as an amount of bottled beverages carried.

In block 82, preflight input is loaded into database 68. The preflight input data specifically relates to the next flight. The data can be input either manually or taken off an airplane computing system automatically. Such parameters may include the city pair, flight length, number of passengers and crew, estimated time of arrival, time of day, and other information that may be deemed important.

In block 84, various system sensor inputs are read. The sensor system inputs include the sensor systems such as the flow or quantity sensors, pressure sensor, and level sensor described above. The information from blocks 80-84 is provided to computing system 54. As mentioned above, the computing system may be part of the central airplane computing system or a standalone system added on to existing airplane hardware. The computing system 54 is used to perform the calculations to determine a desired quantity of water to be stored in the storage tank. The desired amount during a flight may also be calculated. Thus, a fill amount signal or desired amount signal is generated in response to the various information in the database and the sensors. The calculation of water requirement (desired amount or fill amount) is illustrated in block 86. In response to the fill amount of water required, fill valve 18 may be controlled in block 88 so that the amount of water input to the storage tank 14 is limited. That is, the computing system 54 may generate a fill amount signal which in turn is used to control a fill valve control signal. The computing system also stores and collects the various data during the system operation as well as the information calculated and loaded into the database. In block 92 real time data from the level sensor 22, the flight controller and the like may be used to analyze the flight conditions to determine the amount of water on a real time basis to generate a desired water level signal. The water level in the storage tank is compared to the desired water level to determine if water should be rationed or dumped as in block 94. The flight controller may be used to determine various flight conditions such as time remaining, distance remaining and the like. The system has the capability to ration water to various locations. That is, the motorized valves 36 and 42 may be modulated to restrict the flow of water to various portions of the aircraft. Alternatively, the system pressure may be reduced to conserve or ration water.

It should be noted that block 90 is constantly updated using block 92 so that the system becomes adaptive. For example, the next time the flight is made, a more accurate determination may be made.

During operation, the service panel 58 may have various modes of operation including a display mode, a program mode, and a service mode. In display mode, current flight information, water quantity that is measured in the tanks, and whether various statuses are turned on and off may be displayed on the display 64. Examples of information that may be displayed are whether the auto dump condition is on or off, water rationing status is on or off, what the water pressure is, the initial quantity of water, each valve position, and other pertinent system status.

In program mode various data may be entered directly into the system and such things as passenger count may be adjusted. The system may also be configured so that a predetermined water quantity is entered. The program mode may also be used to enable or disable the auto dump feature or the water rationing feature.

The system may also include a service mode that is available to ground service personnel. Filling instructions and quantity may be displayed to such personnel. Instructions and cues to begin filling, drain the system, or dump the system may be controlled through the interface and the display.

As can be seen, by accurately predicting the potable water use for the passengers and crew on a commercial air flight allows a predetermined amount of water to be stored on the aircraft and thus the amount of fuel required for the aircraft can be reduced due to the lower weight associated therewith. Various data may be manually input to the system as well as input from a host of automatic input devices. This minimizes the operator time with the device. For example, a history of data collected is one example of the information stored within the database.

While the invention has been described in connection with one or more embodiments, it should be understood that the invention is not limited to those embodiments. On the contrary, the invention is intended to cover all alternatives, modifications, and equivalents, as may be included within the spirit and scope of the appended claims.

What is claimed is:

1. An adaptive water fill system for an aircraft comprising:
an airplane configuration database generating an airplane configuration signal;
a water level sensor generating a water tank level signal;
a memory;
a user interface for entering pre-flight information in the memory; and
a controller coupled to the configuration database, said water level sensor, said memory, and the user interface, said controller generating a fill amount signal in response to the airplane configuration signal, the tank level signal and the pre-flight information.

2. A system as recited in claim 1 further comprising an aircraft interface communicating between aircraft systems, use points and said controller.

3. A system as recited in claim 1 further comprising a fill valve, said controller generating a fill valve control signal in response to the fill amount, said controller controlling the fill valve in response to the fill valve control signal.

4. A system as recited in claim 1 wherein said controller monitors the water level signal during airplane operation flight, and calculating a desired amount relative to flight conditions.

5. A system as recited in claim 4 wherein when the water level is above the desired amount, said controller opening a dump valve.

6. A system as recited in claim 4 wherein when the water level is below the desired amount, said controller rationing water.

7. A system as recited in claim 6 wherein rationing water comprises restricting flow using one or more valves and/or controlling pump output or other restricting devices, to the whole airplane, zones, or individual use points.

8. A system as recited in claim 1 wherein said controller stores an amount used in the memory, said controller continuously generating a fill amount in response to the amount used.

9. An aircraft comprising:
a water storage tank;
a water flow sensor generating a water flow signal;
an airplane configuration database generating an airplane configuration signal;
a water tank level sensor generating a water tank level signal;
a memory;
a user interface for entering pre-flight information in the memory; and
a controller coupled to the configuration database, said water level sensor, said water flow sensor, said memory, and the user interface, said controller generating a fill amount signal in response to the airplane configuration signal, the tank level signal, the water flow signal and the pre-flight information.

10. An aircraft as recited in claim 9 further comprising a fill valve, said controller generating a fill valve control signal in response to the fill amount, said controller controlling the fill valve in response to the fill valve control signal.

11. An aircraft as recited in claim 9 further comprising aircraft controls generating flight conditions, said controller calculating a desired amount in response to the flight conditions, and the water level signal.

12. An aircraft as recited in claim 9 further comprising aircraft controls and an aircraft communication system generating flight conditions, said controller calculating a desired amount in response to the flight conditions, and the water level signal.

13. A system as recited in claim 12 herein when the water level is above the desired amount, said controller opening a dump valve.

14. A system as recited in claim 12 herein when the water level is below the desired amount, said controller rationing water.

15. A system as recited in claim 14 wherein rationing water comprises restricting flow or operating pressure using a valve.

16. A method of controlling a potable water system on an aircraft comprising:
providing an airplane configuration having configuration information therein;
generating a water tank level signal;
storing preflight information into a database; and
determining a fill amount in response to the configuration information, the water level signal and the preflight information.

17. A method as recited in claim 16 further comprising determining a fill amount in response to the continuously monitored historical data stored in memory and the modifying inputs provided by user and aircraft interfaces.

18. A method as recited in claim 16 further comprising controlling a fill valve in response to the fill amount.

19. A method as recited in claim 16 further comprising monitoring the water level during flight operation;
determining a desired amount of water for a remaining flight; and
comparing the water level to the desired amount.

20. A method as recited in claim 16 wherein when the water level is above the desired level, controlling a dump valve to release water.

21. A method as recited in claim 16 when the water level is below the desired level, generating a ration signal.

22. A method as recited in claim 16 further comprising determining an amount used for a flight, storing the amount used in a memory, and determining a fill amount in response to the amount used.
